(19) United States
(12) Patent Application Publication
(10) Pub. No.: US 2009/0211152 A1
(43) Pub. Date: Aug. 27, 2009

(54) DEVICE FOR KEEPING CUT FLOWERS IN CONDITION, METHOD FOR DISPLAYING CUT FLOWERS, AND A COVER AND HOLDER FOR USE THEREIN

(75) Inventors: Gerardus Johannes Jozef Maria Meeuws, Sterksel (NL); Anton Koning, Tuil (NL); Johannes Petrus Franciscus Maria Burgmans, Westerhoven (NL); Renier Cornelius Petrus Helena Jamers, Utrecht (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Vital Flowers Patent B.V., North Brabant (NL)

(21) Appl. No.: 11/916,709

(22) PCT Filed: Jun. 9, 2006
(86) PCT No.: PCT/NL2006/000285

§ 371 Date: May 16, 2008

(30) Foreign Application Priority Data
Jun. 9, 2005 (NL) 1029222

(51) Int. Cl. A01G 5/06; F25B 21/02; F25D 21/14; F25D 23/00; B65D 85/52; A47G 7/06

(52) U.S. Cl. 47/41.01; 62/3.2; 62/285; 62/259.1; 206/423

(57) ABSTRACT

A device for keeping cut flowers in condition comprises a holder (10) for receiving the cut flowers therein in a suitable medium, in particular water. Cooling means (21, 22) comprise a cooling body (22) which is capable of heat-exchanging contact with at least a part of a wall of the holder for cooling the medium therein. The holder has a bottom with a channel (13) for releasably receiving the cooling body (22) therein. In a method for displaying cut flowers such a holder is placed together with flowers received therein on a cooling body and, when deterioration is imminent, exchanged for a similar holder with a fresh bouquet of flowers.

The present invention relates to a device for keeping cut flowers in condition, comprising a holder for receiving the cut flowers therein in a suitable medium, in particular water, and comprising cooling means with a cooling body which is capable of heat-exchanging contact with at least a part of a wall of the holder for cooling the medium therein. The invention also relates to a method for displaying cut flowers, as well as to a cover and holder for use therein.

A device of the type stated in the preamble is known from a Netherlands patent registered under number 1020544. The device described herein comprises a housing with a tubular shaft, in which a vase-like holder can be releasably placed. Both the holder and the shaft take a conical and mutually close-fitting form so that a cooling body, which is situated about half-way along the housing, enters into contact with a wall of the holder when the holder is received in the housing. The holder is intended for containing cut flowers in a liquid such as water, a gel or jelly, which is thus cooled at the position of the cooling body so as to keep the cut flowers fresh for a longer time.

This known device is particularly intended for showing cut flowers in a shop environment, wherein a number of such housings are integrated in a rack so as to simultaneously display a corresponding number of separate bunches of flowers, particularly bouquets. The view is herein focussed on the crowns of the respective bouquets of flowers.

A drawback of this known device is that the holder is for the greater part received in the not very decorative housing so as to enable adequate cooling, whereby this device is not very suitable for keeping a bouquet of flowers in condition and displaying it at a location where the appearance of the holder in particular makes a significant contribution toward the image of the whole.

This drawback applies less to a device of the type stated in the preamble as known from International patent application WO 01/93662. The holder herein comprises a cylindrical container extending from a base in which the cooling means are accommodated. The cooling means comprise a cooling body in the form of a heat-conducting plate which lies against a bottom part of the container so as to extract heat therefrom. The container and the base herein form one inseparable whole.

Although this known device provides a clear view of the holder, or a decorative casing optionally placed therearound, and of the flowers placed therein, this known device has the drawback that, each time the flowers are changed and the holder optionally cleaned, this also involves the base having therein one or more electrical components of the cooling means. This is particularly inconvenient in use if these components take a wired form for their electric power supply. The cooling of only the bottom part on the underside of the holder also has only a limited effectiveness for warmer zones situated higher in the holder.

The present invention has for its object, among others, to provide a device of the type stated in the preamble which obviates the above described drawbacks of the known devices without forgoing the advantages associated therewith.

In order to achieve the intended object a device of the type stated in the preamble has the feature according to the invention that the holder comprises a bottom with a channel directed toward an interior of the holder, that the cooling means comprise the cooling body at the position of the channel for entering into heat-exchanging contact with a wall of the channel, and that the holder is placed in releasable manner with the channel over at least a part of the cooling body. The cooling body herein protrudes into the channel in the bottom of the holder and thereby cools the holder over the full height of the channel. Not only is it therefore possible to extract heat from the medium in the holder to a greater height, the cold medium in a higher zone will also sink into the holder and thus cause convection currents which have a positive influence on the effectiveness of the cooling process. Because the channel and the cooling body are situated inside the holder, the holder is nevertheless fully visible from the outside, whereby it is also particularly suitable for displaying for instance a bouquet of flowers at a location. Because the holder is per se releasable from the cooling body, the holder can be readily removed for separate filling and optional cleaning. This is particularly advantageous from a practical viewpoint, but the general safety is hereby also served.

A particular embodiment of the device has the feature according to the invention that the cooling body extends from a base in which the cooling means are at least substantially accommodated. The base herein houses at least for the greater part all the components of the cooling system so that the holder can be embodied as a normal vase, wherein the internally oriented channel is formed in the bottom. The holder can herein be placed separately on the base, whereafter the content thereof is cooled in order to keep it fresh longer.

The base preferably takes a completely water-tight form in order to prevent penetration by the medium from the holder, and possible corrosion or short-circuiting as a result thereof. With a view hereto, a further particular embodiment of the device has the feature according to the invention that the base comprises on a contact side a closed metal wall which protrudes inward locally for receiving the cooling body therein and the holder thereover.

The channel of the holder with the cooling body therein is situated inside the holder and partly as a result does not detract from the appearance of the whole, or hardly so. A medium in the holder with flower stems therein will furthermore mask the channel. In order to nevertheless conceal the channel at least almost completely from view, a further particular embodiment of the device has the feature according to the invention that an outer casing extends from the base in order to receive the holder therein. The outer casing can take a completely opaque form or can have a limited translucence so as to thus conceal the presence of the inward-bulging bottom of the holder. The casing moreover contributes toward a correct placing and fixing of the holder on the base. In a further embodiment the device according to the invention herein has the feature that the cooling body is rod-like and extends above the base along a part of the height of the casing.

Any cooling means at all can be applied per se within the scope of the invention. A preferred embodiment of the device according to the invention has the feature however that the cooling means comprise a Peltier element, a cold side of which is in heat-exchanging contact with the cooling body and a warm side thereof with an airflow path of an ambient air. A Peltier element is a thermoelectric component which is able to realize a temperature difference between the warm and cold side thereof in the order of magnitude of 10-50° C. This temperature difference depends on an electrical potential difference applied over the element, and is thus adjustable. On the cold side a temperature in the order of only a few degrees Celsius can thus be achieved at room temperature, while the temperature on the warm side can rise to several tens of degrees Celsius. This temperature range is highly suitable for application in the device according to the invention. Furthermore, a Peltier-element has no moving parts and therefore no mechanical wear. Not only does this result in a long lifespan, but also in silent operation.

The Peltier element is preferably provided on the warm side with a number of cooling fins or otherwise heat-dissipating means for enhancing the discharge of heat generated there to the ambient air. In the case that this alone does not suffice, the invention provides a particular embodiment of the invention, which is characterized in that a fan is arranged in the airflow path for the purpose of carrying a forced airflow to the warm side of the Peltier element during operation. The air which is thus guided in forced manner over the warm side of the Peltier element will continuously absorb the heat relinquished by the Peltier element so that the cold side of the element will always ensure the desired cooling.

Because the cooling means will generally cool below the ambient temperature, the forming of condensation between the cooling body and the holder is a real possibility. In order to discharge this in controlled manner, a further particular embodiment of the device has the feature according to the invention that the bottom of the holder comprises a drainage rib on a base of the channel. Under the drainage projection can be provided a collecting reservoir which is for instance in heat-exchanging contact with a warm side of the cooling means for the purpose of causing the moisture collected therein to evaporate.

For an optimal heat transfer from the holder to the cooling means a preferred embodiment of the device according to the invention has the feature that the cooling body is elongate and protrudes into the channel in at least practically form-fitting manner. An optimal heat contact is thus obtained due to a tight fit of the cooling body in the channel. A further embodiment of the device according to the invention herein has the feature that the cooling body is received in the channel via an adapter body, wherein the adapter body comprises a cavity for receiving the cooling body in at least substantially form-fitting manner therein and has an outer side which lies in at least substantially form-fitting manner in the channel in the bottom of the holder, and that the adapter body is manufactured from a relatively good heat conductor. The adapter body provides the desired close fit between the cooling body on the one hand and the inner wall of the channel on the other. It is hereby possible for instance to manufacture the cooling body in only one embodiment and still tightly connect different holders thereto by means of different modified adapter bodies. In addition, the materials of the inner wall and outer wall of the adapter body can be chosen with a view to a low thermodynamic contact resistance between the materials of the cooling body and the wall of the holder. The adapter body thus enables a mechanical and thermodynamic modification of both components of the device.

The device according to the invention makes it possible, among other things, to considerably prolong the lifespan of cut flowers and thereby limit the costs of the continuous display of cut flowers. In addition, the cooled medium in the holder according to the invention inhibits the growth of bacteria and other micro-organisms, whereby the medium stays clear and fresh for a longer time.

A method for displaying cut flowers at a location therefore has the feature according to the invention that a bouquet of cut flowers is arranged in a holder, the holder is placed in heat-exchanging contact with cooling means at the location and, when deterioration of the bouquet is imminent, the holder with flowers is exchanged for an at least similar holder with a fresh bouquet of cut flowers. Such a method can be carried out by an end user him/herself or be obtained as a service from another party, who for instance makes this his/her profession or business. This other party then has the responsibility for displaying fresh flowers at all times and, when deterioration is imminent, for exchanging the flowers for a fresh bouquet which is supplied in a separate holder.

In order to avoid undesirable splashing of water over an edge of a holder during change-over of the holders or during transport, a particular embodiment of the method according to the invention has the feature that, when the holder is exchanged, an at least substantially liquid-tight cover is closed round the holder with the bouquet therein. The cover herein closes around an upper edge of the holder in order to thus enclose the liquid therein.

The cover can per se be arranged clampingly round an upper side of the holder in order to effectively retain the liquid in the holder. However, so as to ensure that the holder can be lifted and carried without problem by the cover, the invention also relates to a cover for application in the method, which cover is characterized according to the invention in that in closed position the cover comprises a shell which is open on the underside and is otherwise substantially liquid-tight, and which is provided internally close to the underside with a first profile for engaging an at least substantially complementary second profile on an upper side of a holder for cut flowers. Due to the mutual engagement of the two profiles a vertical fixing is achieved when the cover is closed round the edge of the holder. The second profile on the edge of the holder is for instance a ridge which is then received in a corresponding groove as first profile in an inner wall of the cover.

An effective fit of the two edges can avoid water possibly splashing out of the holder being able to seep therebetween. Making a contribution here is a further embodiment of the cover according to the invention, which is characterized for this purpose in that the cover is provided with a liquid barrier on an inner side along the top of the first profile.

In a particularly practical embodiment the cover has the feature according to the invention that the cover comprises two mutually hinged shell parts which are provided with fixation means on a side remote from a hinge side. Such a cover can be folded closed round an upper edge of the holder in simple manner and then held in that situation by means of the fixation means. The cover can optionally be manufactured integrally and in a further particular embodiment has for this purpose the feature according to the invention that the cover is manufactured at least almost wholly from a plastic, in particular polyethylene or polypropylene, in particular by means of thermo-forming such as injection moulding and blow-moulding.

The invention also relates to a holder for application in the device according to the invention, and will now be further elucidated on the basis of several exemplary embodiments and an associated drawing. In the drawing:

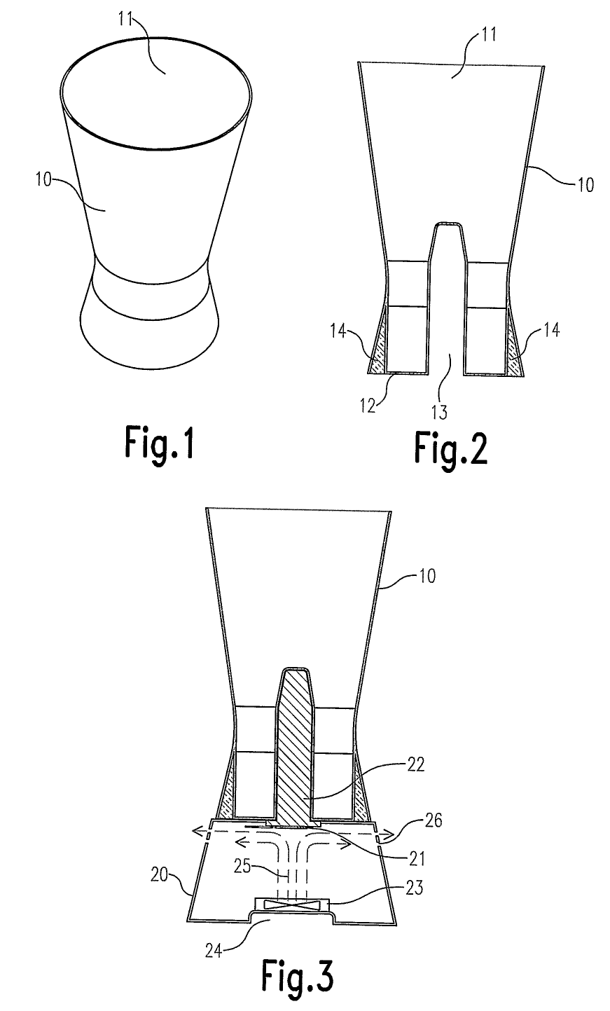

FIG. 1 shows a perspective view of an embodiment of a holder according to the invention;

FIG. 2 shows a cross-section of the holder of FIG. 1;

FIG. 3 shows a cross-section of a first embodiment of a device according to the invention with the holder of FIG. 1;

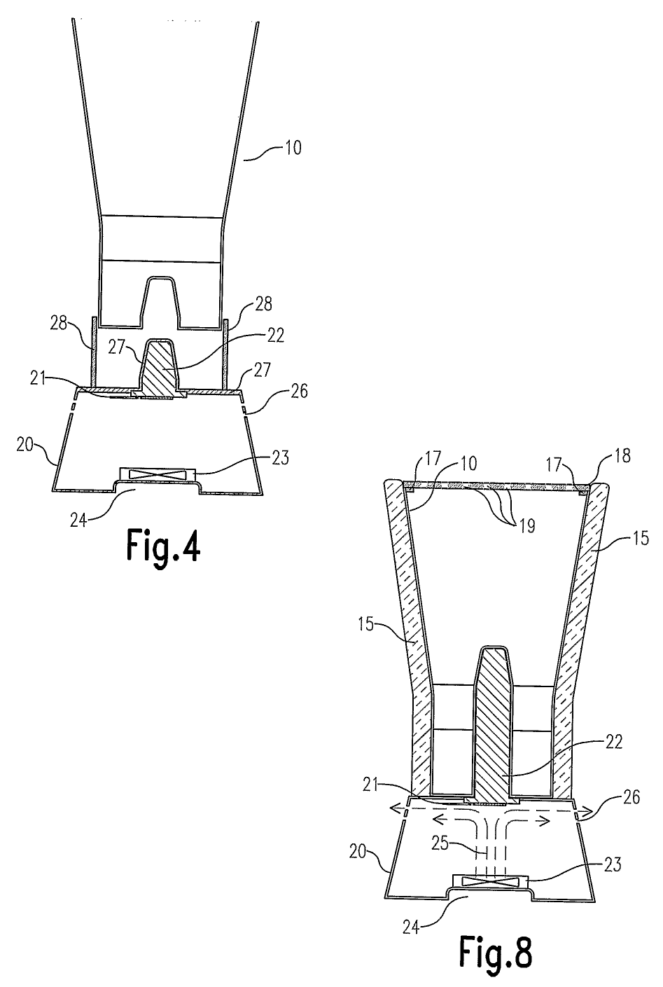

FIG. 4 shows a cross-section of a second embodiment of a device according to the invention;

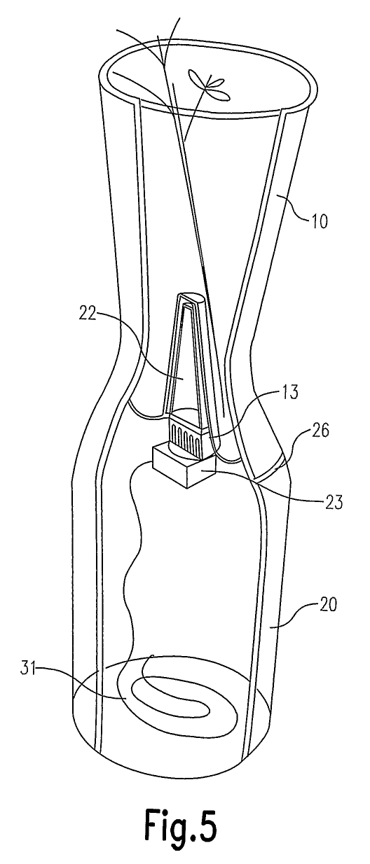

FIG. 5 is a partly cut-away view of a third embodiment of a device according to the invention;

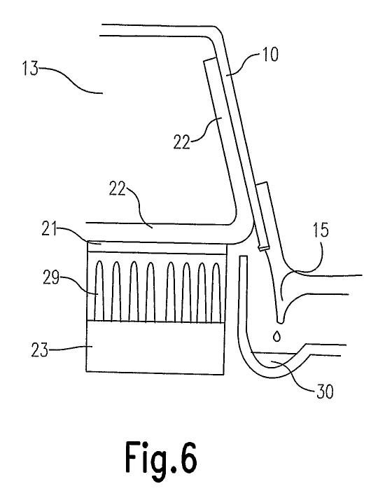

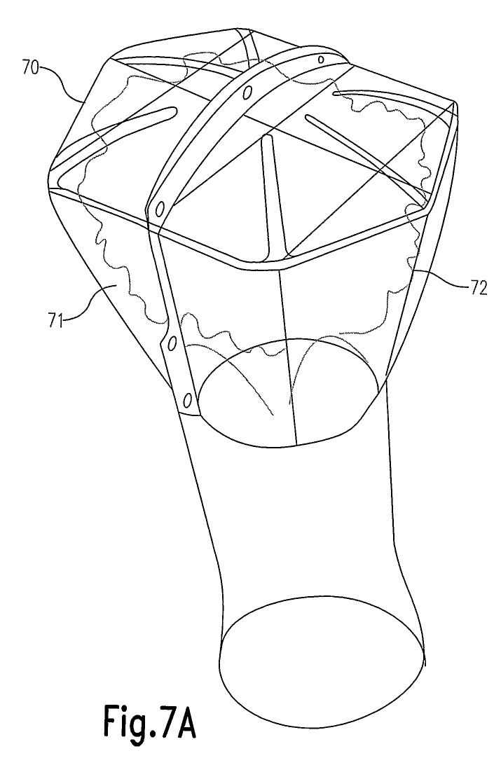

FIG. 6 shows a cross-section of a part of the device of FIG. 5;

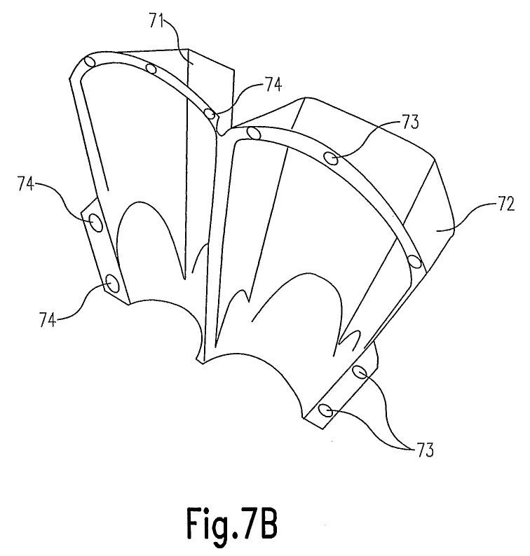

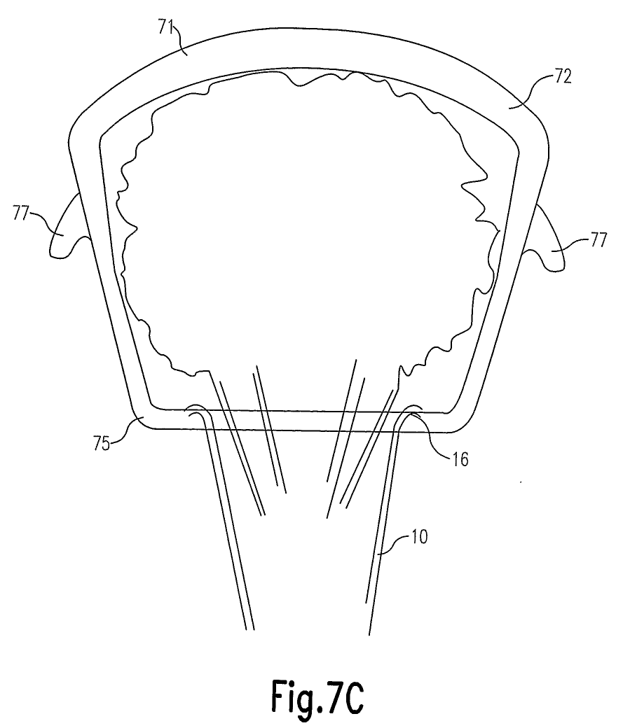

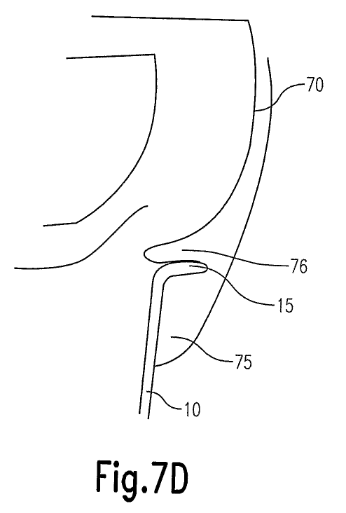

FIG. 7 shows an embodiment of a cover according to the invention; and

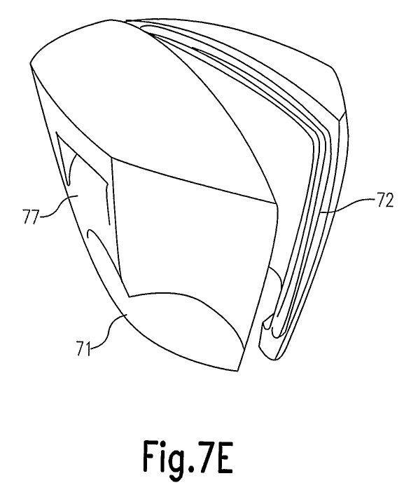

FIG. 8 shows a cross-section of a fourth embodiment of a device according to the invention.

The figures are purely schematic and not drawn to scale. For the sake of clarity some dimensions in particular can be shown exaggerated to greater or lesser extent. Corresponding parts are designated as far as possible in the figures with the same reference numeral.

FIG. 1 shows an embodiment of a holder 10 according to the invention, a cross-section of which is shown in FIG. 2. From the outside the holder 10 has the appearance of a common vase for cut flowers. The holder is manufactured substantially integrally from a suitable plastic by means of injection moulding or other suitable thermo-forming process. In the holder is situated an inner space 11 with a volume in the order of one to several tens of litres for the purpose of receiving a bouquet of cut flowers therein in a suitable medium such as water. Because the holder has been formed integrally, the holder is completely seamless and watertight. For the material of holder 10 a choice can be made from a wide range of plastics, varying from fully opaque to translucent or even transparent plastics.

On its underside the holder comprises a bottom 12 with a channel 13 directed toward inner space 11. The channel is intended for receiving therein in at least practically form-fitting manner a cooling body 22 of the device shown in FIG. 3. This cooling body 22 extends from a base 20 in which active cooling means in the form of a Peltier element 21 are further accommodated. With a cold side this Peltier element 21 is in heat-exchanging contact with cooling body 22, which will hereby acquire a temperature well below the ambient temperature. Arranged in base 20 is a fan 23 which guides a forced airflow 25 from a supply opening 24 and over a warm side of the Peltier element. On the warm side the Peltier element will hereby relinquish its heat to airflow 25 which is then discharged to the outside via ventilation grate or ventilation slot 26 provided for this purpose in an outer wall of the base. Both the Peltier element 21 and fan 23 are provided with an electric power supply (not further shown) which is coupled to the mains electricity via a normal cable.

Holder 10 is per se placed separately on the base with cooling body 22. Due to the precise fit of channel 13 on cooling body 22 there nevertheless occurs a good heat-exchanging contact however between the two parts. The wall of holder 10, and thereby the medium in holder 10, will hereby be cooled continuously at the position of channel 13. On an underside the wall of holder 10 takes a partially double-walled form and is filled with a suitable insulating material 14, such as a polyurethane foam or polystyrene foam, to prevent the possible entry of heat from the outside. Owing to this active cooling of the medium in the holder the flowers received therein will stay fresh considerably longer.

A second embodiment of a device according to the invention is shown in FIG. 4. In this case the device also comprises a holder 10 for receiving therein a bouquet of flowers in water. The volume of holder 10 is adjusted to the size of the bouquet, and typically lies in the order of one to several tens of litres. The holder is manufactured wholly from a transparent plastic such as polymethyl methacrylate (PMMA) to give an attractive view of the flowers received therein. According to the invention a bottom of the holder comprises a channel 13 for receiving therein a cooling element 22 which is coupled to cooling means. In this case the cooling means are also housed in a table model base station 20. On a contact side the base 20 herein comprises a wall 27 which protrudes inward at the position of the cooling body and closes tightly around the cooling body. This avoids water possibly dripping over an edge of holder 10 from being able to enter base station 20. For the purpose of a good heat exchange between cooling element 22 on the one hand and holder 10 with content on the other, a material with good heat-conducting properties is used for wall 27. In this case aluminium has been chosen for this purpose, which material can moreover be processed relatively easily.

Although the cooling element lies fully inside the holder, and already for this reason is hardly visible from the outside, the presence thereof is masked further in the present embodiment by an opaque or slightly translucent outer casing 28 inside which the holder is placed. Outer casing 28 is in this case formed from aluminium and wholly encloses holder 10. The height of outer casing 28 is chosen here to be greater than a length over which rod-like cooling element 22 penetrates into holder 10, so that the cooling element is wholly concealed from view from the outside. The device is otherwise comparable to that of the first exemplary embodiment. If desired, the base can be equipped with an optical sensor or a pressure sensor for recording the possible presence of the holder thereon and for switching on or off the cooling means and fan on the basis thereof, so as to thus prevent unnecessary energy loss and noise.

As well as being a table model in diverse sizes and embodiments, the device according to the invention can also be applied as hanging or standing model. FIG. 5 gives an example of the latter. In the embodiment of the device shown therein cooling means are accommodated in an optionally mobile column 20, whereby the device supports directly on a floor. Resting on the column is a holder 10 with a volume in the order of ten litres or more for receiving a large bouquet of flowers therein. The holder herein leaves a sufficiently wide ventilation slot 26 to enable discharge of warm air from the cooling means.

An integration of cooling means in such a column is shown in more detail in FIG. 6 in a detail sectional view. In this case the cooling means also comprise a Peltier element 21 which, on a cold side and via a cooling element 22, can enter into heat-exchanging contact with an inner wall of holder 10 as soon as this latter is placed on column 20. For this purpose holder 10 is provided in a bottom of an internally directed channel or other inwardly directed projection for receiving cooling element 20 therein. Cooling element 20 in this case takes a conical form in order to fit into the correspondingly formed cavity in the channel. On a warm side of Peltier element 21 a heat sink 29 with fan 23 provides for an effective discharge of the heat generated on this side by element 21. If desired, one or more further fans can be accommodated in column 20 for generating a greater or more distributed airflow. A power supply cable 31 for the electrical components in the device can be stowed in the hollow part of column 20, and optionally be wound therein or thereon, for instance by turning the column 20.

Due to the relatively low temperature prevailing in channel 13 of holder 10 as a result of the presence of cooling body 22, the forming of condensation there is a real possibility. In order to collect and remove possible condensed moisture in controlled manner the holder 10, see FIG. 7, is provided on the underside around channel 13 with a drainage projection 15 which is in register with a collecting reservoir 30 arranged in column 20. This reservoir 30 is situated in the immediate vicinity of the warm side of Peltier element 21, and in particular in the airflow from fan 23, so that condensation water collected therein evaporates quickly and thus has no harmful consequences.

The device shown in FIGS. 5 and 6 is particularly suitable for presenting and displaying cut flowers in conditioned manner in large spaces, in particular of companies and institutions, such as waiting rooms and conference rooms. From a representative viewpoint there is frequently a demand here for an appealing decoration of the space in question. This is provided by an attractively filled vase with fresh cut flowers, albeit that the flowers must appear fresh at all times, since they otherwise cause more harm than good. This latter requires regular replacement of the flowers, which is relatively expensive and can be time-consuming. The invention however provides a method for displaying cut flowers which significantly obviates these drawbacks and for this purpose makes use of a device according to the invention. A bouquet of flowers is herein arranged in a holder according to the invention filled with a suitable medium and thus separately placed, with the channel provided in the bottom, on the cooling body. The conditioning resulting herefrom ensures a significantly longer lifespan of the flowers, so that the frequency with which the flowers must be replaced, and thus also the costs, are reduced significantly.

Before the flowers wilt, the holder with flowers is removed from the cooling body and exchanged for an identical or similar holder with a fresh bouquet of flowers placed therein. This can be realized very quickly and is thereby considerably less time-consuming and labour-intensive at a location than refilling the same vase at the location. This can be done by own staff or be obtained as a service from, or offered as, a business specializing therein.

In order to avoid water or other medium being spilled during exchanging of the filled holder with the bouquet, the invention also provides a cover provided for this purpose. An embodiment of such a cover is shown schematically in FIG. 7. Cover 70 comprises two mutually hinged shell parts 71,72, which are provided on their side remote from the hinge side with fixation means in the form of a number of snap members 73 on the one shell part 72, which fit into eyes 74 corresponding therewith in the other shell part. The cover is formed integrally and wholly from polyethylene or polypropylene foam, and hereby both light-weight and low in cost price.

Such a cover can be readily placed round a holder with flowers therein and folded shut, see FIG. 7C. An internal peripheral edge 75 of the cover herein engages under a recess 15 of the holder so that the holder can be picked up by the cover. Handles 77, by which the whole can be lifted, are provided in or on the cover for an adequate grip. In order to seal in water possibly splashing out of the holder and to prevent it from exiting the holder, the cover is provided on an inner side along peripheral edge 75 with a liquid barrier 76 which guides back inside any water possibly falling thereon. The invention thus provides a particularly complete and practical solution for keeping in condition and displaying cut flowers.

A fourth exemplary embodiment of a device according to the invention is shown in FIG. 8. In this embodiment the holder comprises an inner vase 10 in combination with an insulated outer vase 15. Inner vase 10 is herein freely removable from outer vase 15 and fits with a channel over cooling element 22. The inner vase is preferably, at least in the channel, embodied with a single wall for an effective heat exchange with cooling element 22. Conversely, outer vase 15 is double-walled so as to provide an effective lateral insulation of the medium received in the holder. The outer vase can be formed from any desired material so as to give a desired appearance. Use can be made here of both translucent and opaque materials as desired. Resort can herein be made to many types of plastic, but it is also possible to opt for a natural product such as wood, glass or (natural) stone or for a metal outer vase. For the inner vase use is preferably always made of a uniform product, in particular a dishwasher-safe plastic, this being particularly advantageous from a logistic viewpoint. In the case of a translucent outer vase, a translucent or even almost wholly transparent embodiment is preferably also chosen for the inner vase in order to affect as little as possible the overall impression given by the outer vase.

When a bouquet of flowers is exchanged, the inner vase 10 with the bouquet can be removed easily and exchanged for a new bouquet in its own inner vase. After possible deposition or other contamination has been removed, the used inner vase is ready for reuse. Inner vase 15 is therefore preferably manufactured from a dishwasher-safe material. In order to facilitate the exchange of the inner vase, grip means 17 can be provided on an upper edge thereof, such as for instance an opening or recess in an inner wall thereof or, conversely, as in this example, a rib, protrusions or other type of local thickening by which the inner vase can be grasped and lifted, with content, out of the outer vase.

If desired, inner vase 10 can be covered with a lid 18 in which perforations are provided at the correct positions for passage of flower stems. Not only does such a lid enhance the insulation of the medium received in the holder, the perforations 19 also facilitate the arrangement of a new bouquet in correct manner. Lid 18 can be placed loosely on the inner vase or fixed thereon, for instance by means of a bayonet or threaded connection, in which case lid 18 can advantageously be provided with the above described grip means.

Outer vase 15 can be a separate body but, as in this embodiment, also be formed integrally with base station 20 in which cooling means 21 are arranged. The whole thus consists essentially of two parts, i.e. an exchangeable inner vase 10 in an outer vase 15 which supports on a base and contains the components required for cooling of inner vase 10. In this embodiment use is made here of a table model outer vase, but it is also possible instead to opt for a standing model which is placed on a floor and has a height in the order of 50-150 cm. By giving at least an outer side thereof an attractive design, a particularly attractive and representative whole can thus be obtained, which is particularly practical in use owing to the removable inner vase and provides a prolonged lifespan of a bouquet of flowers received therein owing to the integrated cooling according to the invention.

Although the invention has been further elucidated above on the basis of only several exemplary embodiments, it will be apparent that the invention is by no means limited thereto. On the contrary, many variations and embodiments are still possible within the scope of the invention. The holder according to the invention can for instance be applied with a separate cooling body which is here wholly received in the channel so that the overall appearance is that of the holder, possibly supplemented with a connecting cable. The design of the holder and of the base can also be varied as desired to adapt it to an interior of a surrounding space or the individual taste of the (end) user.

In order to achieve a greater contact surface between the cooling body and the wall of the holder at the same height, a spiralling cooling body and a similar channel can for instance be applied instead of the shown straight and rod-like cooling body. The holder can herein be arranged on or released from the cooling body by means of a rotating movement.

Instead of a standing form the holder can also take a hanging form, wherein the suspending means preferably comprises an electrical connection for the cooling element. Different holders, each with a fitting channel but with a different design and/or colour scheme, can be placed on a base station in order to adapt the whole to the rest of the interior of a space, to the nature and colour of the bouquet of flowers, or simply to the wishes of an (end) user.

The materials and sizes used in the examples can be modified as desired so as to meet a specific requirement. In respect of this requirement the invention can for instance be applied in a house for personal use as well as by companies and institutions for commercial use. With an eye to this latter field of application, the device can be particularly modified and adapted to a possible corporate identity of the (end) user, for instance by embodying the device in a specific colour scheme or shape, or by providing the device with an identifying symbol such as a company name or logo.

The above described method according to the invention can advantageously be applied in conjunction with the described device and holder according to the invention, but can in addition also be applied with other types of device and holder wherein cooling means are utilized for conditioning a bouquet of flowers at a location.

1-17. (canceled)

18. Apparatus for keeping cut flowers in condition, said apparatus comprising:
a holder having a wall defining an interior to receive cut flowers therein and a suitable medium for the flowers, said holder including a bottom with a channel directed toward the interior of said holder;
a cooling device to cool the medium in the holder, said cooling device including a cooling body in heat-exchanging contact with at least a part of the wall of said holder, said cooling body being disposed at least partly within the channel to enter into heat-exchanging contact with a wall of the channel; and
a releasable connection between the channel and at least part of the cooling body permitting said holder to be separated from said cooling device.

19. The apparatus as claimed in claim 18, further comprising a base in which the cooling device is at least substantially contained and wherein said cooling body extends from said base.

20. The apparatus as claimed in claim 19, wherein said base comprises a closed metal wall having a contact portion protruding inwardly for receiving the cooling body therein and said holder being configured to fit over the contact portion.

21. The apparatus as claimed in claim 20, further an outer casing extending from said base in order to receive a portion of the holder therein.

22. The apparatus as claimed in claim 21, wherein said cooling body is rod-like and extends above said base along a part of the height of said casing.

23. The apparatus as claimed in claim 18, wherein said cooling device comprises a Peltier element, a cold side of which is in heat-exchanging contact with said cooling body and a warm side thereof in contact with an airflow path of ambient air.

24. The apparatus as claimed in claim 23, further comprising a fan arranged in the airflow path for the purpose of carrying a forced airflow to the warm side of the Peltier element during operation.

25. The apparatus as claimed in claim 18, wherein the bottom of said holder comprises a drainage projection on a base of the channel.

26. The apparatus as claimed in claim 18, wherein said cooling body is elongate and protrudes into the channel in a substantially form-fitting manner.

27. The apparatus as claimed in claim 26, wherein said cooling body is received in the channel via an adapter body, and wherein the adapter body comprises a cavity for receiving said cooling body in a substantially form-fitting manner and has an outer side disposed in substantially form-fitting manner in the channel, and said adapter body is manufactured from a relatively good heat conductor.

28. A method for displaying cut flowers at a location, said method comprising the steps of:
placing a first bouquet of cut flowers in a first holder in heat-exchanging contact with a cooling device at the location: and
when deterioration of the bouquet is imminent, exchanging the first holder with the first bouquet of flowers therein with a second holder having a fresh second bouquet of cut flowers therein.

29. The method as claimed in claim 28, wherein the second holder has a substantially liquid-tight cover, and further comprising closing the cover after the first holder is exchanged for the second holder.

30. A cover for enclosing an open top of a holder for supporting flowers therein, said cover comprising:
a shell having open and closed positions, said shell being substantially liquid-tight in the closed position except for opening on its underside; and
a first profile disposed adjacent to the underside of the shell to engage a substantially complementary second profile on an upper side of the holder for connecting the cover to the holder.

31. The cover as claimed in claim 30, further comprising a liquid barrier disposed inside and along a top portion of the shell.

32. The cover as claimed in claim 30, wherein said shell comprises two parts connected together by a hinge, each of said hinged shell parts including fixation means on a side of the hinged part remote from the hinge for releasably connecting the shell parts together.

33. The cover as claimed in claim 30, wherein said cover is manufactured in large part from a plastic material.

34. The cover as claimed in claim 33, wherein said plastic material comprises at least one material selected from the group consisting of polyethylene or polypropylene, and said cover is made by a thermo-forming process.

35. The cover as claimed in claim 30 in combination with the holder for supporting flowers therein.
